(19) United States
(12) Patent Application Publication
(10) Pub. No.: US 2026/0021840 A1
(43) Pub. Date: Jan. 22, 2026

(54) HIGH-PAYLOAD AUTONOMOUS MOBILE ROBOT HAVING TILLER HOMING MODULE

(71) Applicant: Teradyne, Inc., North Reading, MA (US)

(72) Inventor: Frederik Tøt Nielsen, Hindsløkken (DK)

(73) Assignee: Teradyne, Inc., North Reading, MA (US)

(21) Appl. No.: 18/780,362

(22) Filed: Jul. 22, 2024

(51) Int. Cl. B62B 3/00; B62B 3/06; B62B 5/00; B62B 5/06; B66F 9/06; B66F 9/075

(52) U.S. Cl. CPC B62B 3/001; B62B 5/0069; B62B 5/067; B66F 9/063; B66F 9/0759; B62B 3/0612; B62B 5/063

(57) ABSTRACT

High payload autonomous mobile robots (AMRs) are described. The AMRs may include a tiller rotatable about multiple axes. permitting manual operation of the AMR. The AMRs may further comprise a homing module configured to return the tiller to a default orientation about the second axis. for example when an operator stops using the tiller.

### BACKGROUND

### Field

The present application relates to a high-payload autonomous mobile robot having a tiller homing module.

### Related Art

Mobile robots can move autonomously or through guidance to complete one or more actions. High payload mobile robots can carry a load and move the load from one location to another.

### BRIEF SUMMARY

In some embodiments, a high payload autonomous mobile robot includes a body, a rotatable coupler coupled to the body, and a tiller to rotate relative to the body around a first axis and a second axis. The tiller is coupled to the body by the rotatable coupler and rotates around the first axis through action of the rotatable coupler. A tiller head is coupled to the tiller and has a wider footprint than the tiller. A homing module is coupled between the body and the rotatable coupler and returns the tiller to a default orientation about the second axis.

In some embodiments, a high payload autonomous mobile robot includes a body and a controller to operate the high payload autonomous mobile robot in an autonomous mode. The high payload autonomous mobile robot also includes a tiller for use in a manual mode of the high payload autonomous mobile robot, and a homing module coupled to the body and to return the tiller to a default rotational orientation relative to the body in the autonomous mode.

In some embodiments, a high payload autonomous mobile robot includes a body, a tiller having a first end coupled to the body and a second end having a handle, the first end being opposite the second end. A rotatable coupler couples the tiller to the body, and the high payload autonomous mobile robot also includes means for restoring the tiller to a default rotational orientation relative to the body.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 is a perspective view of a mobile robot according to one or more embodiments.

FIG. 2A shows the tiller rotated around a first axis relative to the body of the mobile robot according to one or more embodiments.

FIG. 2B shows the tiller rotated around a second axis relative to the body of the mobile robot according to one or more embodiments.

FIG. 3A details aspects of a homing module of a mobile robot in a state in which the tiller is in use according to one or more embodiments.

FIG. 3B details aspects of a homing module of a mobile robot in a stowed state according to one or more embodiments.

FIG. 4A details aspects of one of the disks of a homing module according to one or more embodiments.

FIG. 4B details aspects of one of the disks of a homing module according to one or more embodiments.

FIG. 5 illustrates the tiller head in three different positions relative to the tiller according to one or more embodiments.

FIG. 6 shows aspects of the tiller assembly that couple the tiller to the body of the mobile robot according to one or more embodiments.

### DETAILED DESCRIPTION

Mobile robots may be used in various applications. For example, high payload mobile robots such as tuggers, forklifts, stackers, and jacks may transport boxes, palettes, or other objects in a warehouse, fulfillment center, or other facility. As an example, a high payload mobile robot may include prongs that can be positioned to slide below a palette and lift it up for transport such that the mobile robot serves the function of a conventional forklift but is driverless.

Some mobile robots are autonomous mobile robots (AMRs) but may additionally allow for manual manipulation of the position of the mobile robot in a manual mode. The mobile robot may include a tiller permitting manual operation through operator manipulation of the tiller. For example, the operator may use the tiller to pull, push, or turn the mobile robot when operated in a manual mode.

The tiller of the AMR may be moved around multiple axes into different orientations with respect to the body of the AMR. In some embodiments, the multiple axes are perpendicular to each other. For instance, from the perspective of an operator facing the body of the mobile robot, the tiller may be rotated around a first, horizontal axis and may also be moved from side to side around a second, vertical axis. That is, the tiller may be moved around a first axis and/or a second axis relative to the body of the mobile robot.

The inventors have recognized that automatic stowing of the tiller of an autonomous mobile robot to a default position, also referred to as the home position or stowed position, increases convenience and ensures that the tiller does not interfere with subsequent storage or autonomous operation of the mobile robot. The tiller may have a default position when not in use. The default position may be designed to reduce (e.g., minimize) the footprint of the AMR when the tiller is not in use. For example, the tiller may be folded against or into the body of the AMR. When the tiller is out of its default position during manual operation of the mobile robot the footprint of the mobile robot is increased. The increased footprint of the mobile robot may be undesirable when the tiller is not in use, for example when the mobile robot itself is not in use or is operating in autonomous mode, because, for example, the increased footprint may result in collisions with other objects. For example, if the tiller is sticking out from the body of the AMR when the tiller is not in use it may strike a person, wall, or other machinery in its environment. Requiring the operator to manually return the tiller to its default position is undesirable since the operator may be distracted, forget, or otherwise fail to manipulate the tiller back to the default position. The inventors have recognized that automatic stowing of the tiller may therefore be beneficial.

According to one or more embodiments, a homing feature is implemented to automatically stow the tiller to its default position. The tiller is coupled to a homing module integrated on or into the body of the mobile robot. According to some embodiments, the homing module may include features to return the tiller to a default orientation around one or more axes around which the tiller may rotate. The homing module may be entirely passive in at least some embodiments and may include only mechanical components in some embodiments.

According to one or more embodiments, the homing module may include complementary disks that have ramped (or otherwise non-planar) surfaces facing each other. The ramped surfaces may naturally force the disks into a stable, keyed orientation. For example, when the ramped surfaces of the disks are aligned in a keyed orientation, the two disks may in combination form a disk of a uniform (solid) thickness. The tiller may be coupled to the homing module such that rotation of the tiller about an axis (e.g., a vertical axis with respect to the body of the AMR) requires applying a force to overcome the stable positioning of the disks. For instance, an operator may apply a torque to the tiller forcing the disks away from their keyed orientation. When the operator removes the torque from the tiller, the ramped surfaces of the disks may cause the disks to return to their stable, keyed orientation. The tiller may be in its default position when the disks are in their keyed orientation.

In some embodiments, the material of the two disks may be different, which may facilitate sliding of the disks relative to each other. For example, one of the disks may be made of a material (e.g., steel) that is harder than the material (e.g., nylon) of the other disk. One of the disks may be made of a material (e.g., nylon) that facilitates sliding of the disk(s).

In some embodiments in which the homing module includes complementary disks having a keyed orientation, a force may be applied to one or both of the disks to return the disks to their keyed orientation. For example, the relative rotation of the disk(s) into the keyed orientation may be caused by a restoring force applied on one or both of the disks by a resilient member, such as a coil spring. Because the tiller is coupled to the rotating disk, the tiller, too, rotates with the rotating disk until the keyed orientation of the disks (representing the stowed orientation of the tiller around one axis) is achieved. A disk spring or any resilient member may be used to apply the restoring force on the rotating disk according to alternate embodiments. In other embodiments, two complementary springs may be used instead of two complementary disks and a spring.

According to one or more embodiments, the AMR may further comprise a gas spring (e.g., nitrogen gas spring) to return the tiller to the stowed orientation around a horizontal axis with respect to the body of the AMR. The gas spring may be part of a rotatable coupler that couples the tiller to the mobile robot. The rotatable coupler may be part of a tiller assembly that is coupled to the rotating disk by one or more disk couplers. The gas spring may facilitate rotation of the tiller about a different axis than the axis around which the rotating disk(s) moves the tiller.

According to one or more embodiments, the tiller may have a hinged coupling to a tiller head. The tiller head may include handles and controls for operation by an operator. A second gas spring may be associated with the tiller head. This second gas spring may be bistable and facilitate two default positions of the tiller head relative to the tiller. One of the default positions of the tiller head may be a stowed position in which the controls on the tiller head face the body of the mobile robot. The other default position of the tiller head may be a position in which the tiller head is angled relative to the tiller to facilitate operation of the controls on the tiller head by an operator holding handles of the tiller head. According to some embodiments, an operator may push the tiller head out of the second position when manual manipulation of the mobile robot is completed. The second gas spring may then return the tiller head to the stowed default position. According to some embodiments, stowing the tiller after manual manipulation of the mobile robot by an operator may require operation of the second gas spring to stow the tiller head, in addition to operation of the gas spring and homing module to return the tiller to alignment with both axes around which the tiller rotates.

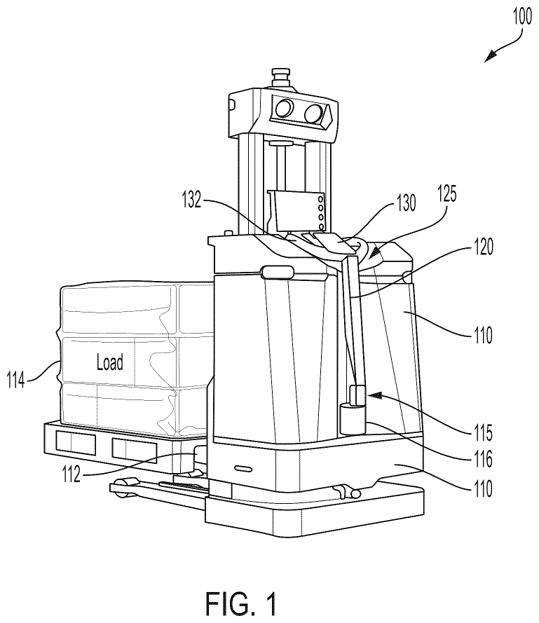

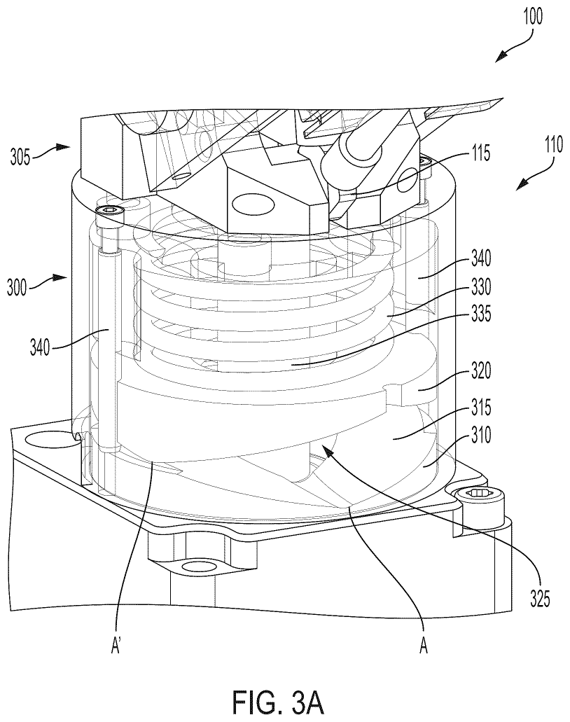

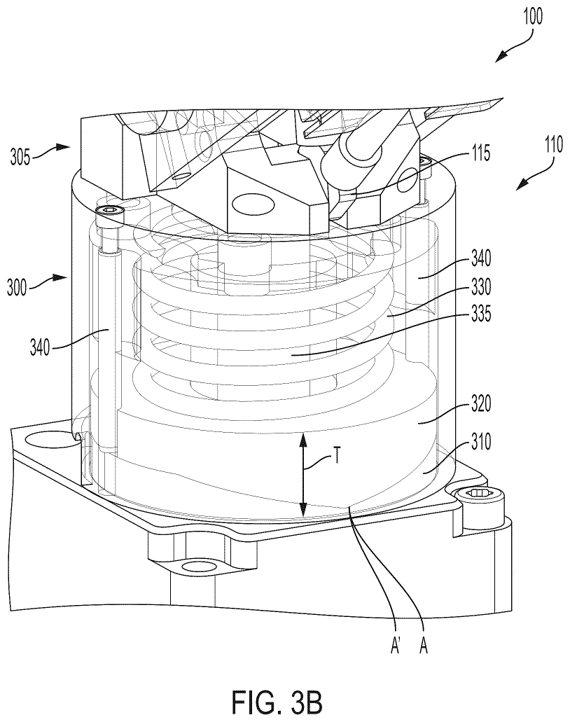

FIG. 1 is a perspective view of a mobile robot 100 according to one or more embodiments. The exemplary mobile robot 100 shown in FIG. 1 is a high payload autonomous mobile robot (AMR) that may autonomously pick up and carry a load. For example, the mobile robot 100 may be a high payload pallet jack in some embodiments. The mobile robot 100 has a body 110 that may contain a controller for controlling autonomous operation of the mobile robot. The mobile robot 100 includes one or more forks 112 for engaging with a load 114 (e.g., a pallet) to be carried. A tiller 120 is shown on a side of the mobile robot 100 that is opposite the side where the load 114 is carried. The tiller 120 couples to the body 110 via a rotatable coupler 115. As discussed in further detail below with reference to FIG. 3A, the rotatable coupler 115 is part of a tiller assembly 305 coupled to the body 110 of the mobile robot 100. Referring again to FIG. 1, the mobile robot 100 includes a homing module 116 coupled to the body 110 and the rotatable coupler 115. In the illustrated embodiment, the homing module 116 is mechanically coupled between the body 110 and the rotatable coupler 115. At an opposite end of the tiller 120 from the rotatable coupler 115, the tiller 120 is coupled to a tiller head 130 that may include handles 132 for use by an operator. As shown, the tiller head 130 is in a face-down position, meaning that controls on the tiller head for use by an operator are stowed against the body 110. A hinge 125 facilitates rotation of the tiller head 130 relative to the tiller 120 so that the controls are available to the operator when the tiller is pulled away from the body 110.

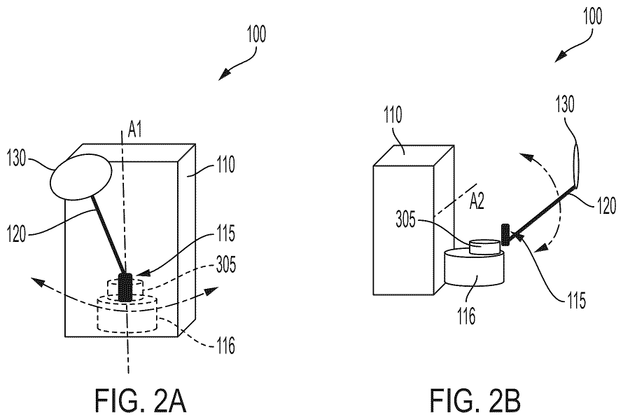

FIGS. 2A and 2B illustrate in simplified form different exemplary configurations in which the tiller 120 of the mobile robot 100 shown in FIG. 1 may be positioned for use by an operator, and in particular illustrate rotation of the tiller 120 about two axes. FIG. 2A shows the tiller 120 rotated around an axis A1 relative to the body 110 of the mobile robot 100 as indicated by the double arrows. In the exemplary orientation shown in FIG. 2A, the axis A1 is vertical such that the tiller 120 can be positioned to a side of the body 110 based on rotation around the axis A1. Rotation of the tiller 120 about the axis A1 is permitted by the homing module 116, which couples to the tiller 120 via a tiller assembly 305 that is further discussed with reference to FIG. 3A. FIG. 2B shows the tiller 120 rotated around an axis A2 relative to the body 110 of the mobile robot 100 as indicated by the double arrows. Rotation about the axis A2 is permitted by the rotatable coupler 115. In the exemplary orientation shown in FIG. 2B, the tiller 120 can be moved up or down based on rotation around the axis A2.

As noted, the tiller 120 can be rotated around both axes A1, A2. For example, in FIG. 2A, the tiller 120 is moved down from its stowed position (i.e., rotated around axis A2) and to the left (i.e., rotated around axis A1) relative to the body 110 of the mobile robot 100. The axes A1 and A2 may be perpendicular to each other in some embodiments.

FIGS. 3A and 3B detail aspects of a homing module 300 which may be an example implementation of the homing module 116 of mobile robot 100 according to one or more embodiments. FIG. 3A details aspects of a homing module 300 when the tiller 120 is rotated around axis A1 (as shown in FIG. 2A). FIG. 3B details aspects of the homing module 300 when the tiller 120 is in its default orientation with respect to axis A1. The exemplary embodiment shown in FIGS. 3A and 3B includes disks 310, 320 and a coil spring 330 below the rotatable coupler 115 that couples the tiller 120 to the body 110 of the mobile robot 100. A post 335 is coupled to the disk 320 and to a tiller assembly 305 that includes the rotatable coupler 115 that couples to the tiller 120.

The post 335 may have bearings below its base to allow rotation of the post 335. In addition, the post 335 may couple to an encoder to facilitate a digital readout of its orientation. The encoder may allow the autonomous system of the mobile robot 100 to determine when the tiller 120 is stowed so that, for example, movement of the mobile robot 100 via the autonomous system may safely commence. On an opposite end of the base, the post 335 couples to the tiller assembly 305 such that rotation of the post 335 based on rotation of the disk 320 results in rotation of the tiller assembly 305 and the tiller 120 coupled to the tiller assembly 305.

As previously noted, rotation of the tiller 120 about the axis A1 (as shown in FIG. 2A) is permitted by the homing module 300. More particularly, according to the exemplary embodiment, rotation of the disk 320 of the homing module 300 results in rotation of the tiller 120 around the axis A1 based on coupling of the disk 320 to the tiller assembly 305 via the post 335 and via coupling of the tiller assembly 305 to the tiller 120 via the rotatable coupler 115. In addition to the post 335, supports 340 may provide support to the tiller assembly 305, as shown, for example by coupling the disk 320 to the housing 355 of the homing module 300. As shown in FIG. 3A, the disk 310 includes a ramped surface 315 that faces a ramped surface 325 of the disk 320. In the exemplary illustration, the surface opposite the ramped surface 315, 325 is flat for both disks 310, 320.

In the default (stowed) orientation of the tiller relative to axis A1, as shown in FIG. 3B, the position A on disk 310 mates with the position A′ on disk 320 and the combination of disk 310 and disk 320 appears as a disk with a uniform solid thickness T. When an operator rotates the tiller 120 around the axis A1 (as shown in FIG. 2A), the disk 320 rotates along with the tiller 120 and is taken out of the complementary, default (i.e., stowed) position, as shown in the exemplary illustration of FIG. 3A. As long as an operator holds the tiller head 130 and overcomes the force exerted by the coil spring 330 on the disk 320, the tiller 120 may be kept out of the default orientation around the A1 axis.

Once the operator releases the tiller head 130, force applied on the disk 320 by the coil spring 330 pushes the disk 320 toward the disk 310 and causes the disk 320 to rotate. That is, the coil spring 330 is compressed when the tiller 120 is taken out of the default orientation based on the coupling of the tiller assembly 305 with the disk 320 via the post 335. This is because rotation of the tiller 120 causes rotation, out of the default orientation, of the disk 320 based on the coupling via the post 335 to the tiller assembly 305. The displacement of the disk 320 from the default orientation in turn causes compression of the coil spring 330. When the restoring force exerted by the coil spring 330 (to re-expand) is no longer resisted by an operator holding the tiller head 130, the restoring force is applied on the disk 320. The coil spring 330 may be designed such that its restoring force can be overcome by an adult without undue strain but its restoring force is sufficient to ensure return of the tiller 120 to its default orientation relative to axis A1 (i.e., aligned with axis A1). The restoring force may be on the order of about 400 Newtons, for example. According to the orientation shown in FIGS. 3A and 3B, the restoring force applied by the coil spring 330 is a downward force on the disk 320. The downward force on the disk 320, in combination with the ramped surfaces 315, 325, causes rotation of the disk 320 into the default position, as shown in FIG. 3B. For example, the position A′ on the disk 320 may slide along the ramped surface 315 of the disk 310 until position A′ settles opposite position A on the disk 310 (i.e., the stowed orientation).

The material of the disks 310, 320 may be different. For example, the material of the disk 310 may be harder than the material of the disk 320 (e.g., nylon). According to one or more embodiments, the material of disk 310 may be steel while the material of the disk 320 is a polymer which has self-lubricating properties when interfacing with steel (e.g. ultra-high-molecular-weight polyethylene (UHMW PE), polyethylene terephthalate (PETP), nylon, polyamide (PA) nylon). The difference in material of the disks 310, 320 may facilitate sliding of the disk 320 along the ramped surface 315 of the disk 310.

While the disks 310, 320 and coil spring 330 are shown as an exemplary embodiment of the homing module 300, alternate embodiments may include a different type of spring (e.g., disk spring) or other type of resilient member than a spring to apply the restoring force on the rotating disk 320. In other embodiments, two complementary springs may be used instead of the two complementary disks 310, 320 and the coil spring 330 or other resilient member. That is, the particular means for realigning the tiller 120 with the axis A1 may differ according to various embodiments.

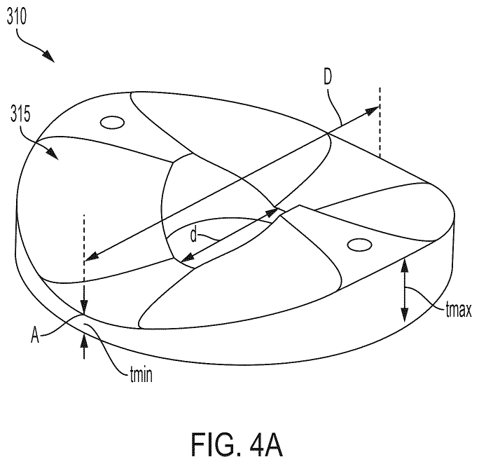

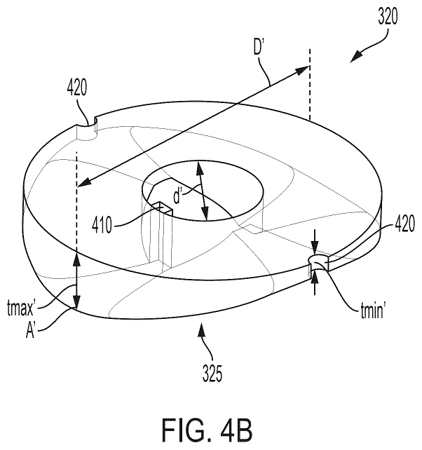

FIGS. 4A and 4B show aspects of the disks 310, 320 that are part of the homing module 300 according to one or more embodiments such as the exemplary embodiment shown in FIGS. 3A and 3B. FIG. 4A shows the disk 310. The disk 310 has an outer diameter D, and an inner diameter d that accommodates the post 335, as shown in FIG. 3A, for example. The ramped surface 315 of the disk 310 causes the disk to have a maximum thickness tmax on opposite ends of the disk 310 that decreases gradually to a minimum thickness tmin on opposite ends (indicated as A on one of the ends). The exemplary disk 310 shown in FIG. 4A has a planar surface on the side opposite the side with the ramped surface 315.

FIG. 4B shows the disk 320. The disk 320 has an outer diameter D′ and an inner diameter d′. Indentations 420 in the disk 320 may accommodate the supports 340 when the disks 310, 320 are aligned (i.e., when the tiller 120 is stowed). The inner diameter d′ of the disk 320 may be the same as or smaller than the inner diameter d of the disk 310. A protrusion 410 into the inner diameter d′ of the disk 320 engages with the post 335 to couple the disk 320 with the tiller assembly 305 via the coupling of the post 335 with the tiller assembly 305, as discussed with reference to FIG. 3B. Coupling of the post 335 to the disk 320 may be achieved via alternative means according to some embodiments. Like the ramped surface 315 of disk 310, the ramped surface 325 of disk 320 causes the disk to have a maximum thickness tmax′ on opposite ends of the disk 320 that decrease gradually to a minimum thickness tmin′ at opposite ends. The maximum thickness on one of the ends is indicated as A′. In the stowed orientation of the tiller 120 (as shown in FIG. 3B), the positions A and A′ on the disks 310 and 320 align.

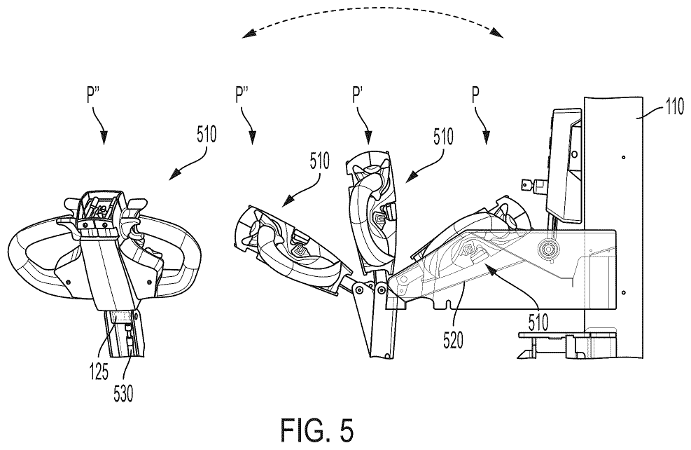

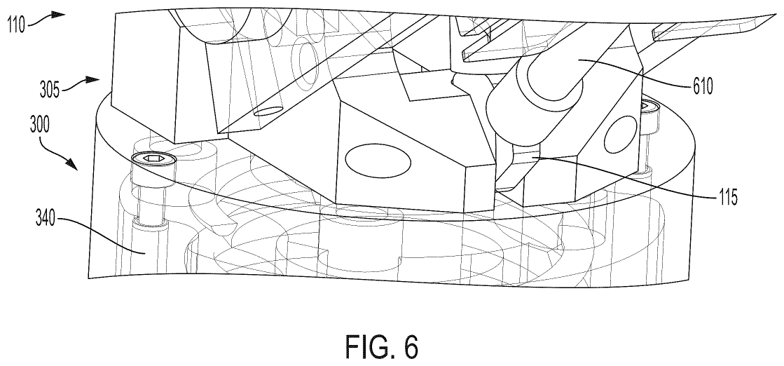

FIGS. 5 and 6 illustrate aspects of the tiller assembly 305, including the tiller 120 and tiller head 130, according to one or more embodiments. FIG. 5 illustrates the tiller head 130 in three different positions P, P′, P″ relative to the tiller 120. In position P″, two different views are shown. In one of the views, the tiller 120 is not rotated around axis A1 (FIG. 2A) such that the angle of the tiller head 130 relative to the tiller 120 is clear. In the second view, the tiller 120 is rotated (around axis A1) to show the hinge 125 and gas spring 530 associated with the tiller head 130.

The tiller head 130 may have two default positions based on the gas spring 530 being bistable. For example, position P of the tiller head 130 is one of the default positions, and position P″ is a second default position of the tiller head 130. The hinge 125 may facilitate rotation of the tiller head 130 relative to the tiller 120, as indicated by the dashed arrow. When the tiller 120 is in the stowed position, the tiller head 130 may be in position P, one of the default positions. In this position, the controls 510 on one side of the tiller head 130 may face the body 110. As shown in FIG. 5, the body 110 may include an indentation 520 that accommodates a portion of the tiller head 130 such that all of the tiller head 130 is not above a surface of the body 110.

An operator may pull the tiller head 130 out of the position P to position P′, revealing the controls 510 on a side of the tiller head 130. According to the exemplary embodiment shown in FIG. 5, to move the tiller head 130 from position P to P′, the operator pulls the tiller head 130 with sufficient force to overcome the force applied by a gas spring 530. The operator may continue to pull the tiller head 130 to position P″, another default position of the tiller head 130 relative to the tiller 120.

To stow the tiller 120 completely, prior to letting go of the tiller head 130, the operator may push the tiller head 130 toward the body 110 of the mobile robot 100 with sufficient force to overcome the force applied by the gas spring 530 to keep the tiller head 130 in position P″, one of the default positions. Pushing the tiller head 130 out of position P″ may cause the gas spring 530 to return the tiller head 130 to position P, the other default position (i.e., stowed position) of the tiller head 130 relative to the tiller 120. Letting go of the tiller head 130 may activate the homing feature described with reference to FIGS. 3A and 3B. That is, the disks 310, 320 and coil spring 330 or other means may return the tiller 120 to be aligned with axis A1.

FIG. 6 shows aspects of the tiller assembly 305 that couple the tiller 120 to the body 110 of the mobile robot 100 according to one or more embodiments. The gas spring 610 associated with the tiller 120 may facilitate another aspect of the stowing operation, which involves rotating the tiller 120 around axis A2 shown in FIG. 2B to realign with the axis A2. The gas spring 610, in conjunction with the gas spring 530 associated with the tiller head 130, facilitates moving the tiller head 130 to the positions P, P′, and P″ shown in FIG. 5. That is, in addition to overcoming the restoring force of gas spring 530 to move the tiller head 130 from stowed position P to P′, an operator may additionally overcome the restoring force of gas spring 610 to pull the tiller 120 away from the body 110 of the mobile robot 100 to reach position P″.

When the tiller head 130 is out of the stowed position, the tiller 120 is rotated relative to axis A2 (e.g., pulled away from the body 110), and the tiller 120 is rotated relative to axis A1 (moved from one side of the body 110 to another), as shown in FIG. 5 for the position P″ with the hinge 125 visible. Thus, in some embodiments three mechanisms may be involved in restoring the tiller to the stowed position (e.g., as shown in FIG. 1). Based on the operator pushing the tiller head 130 out of the second default position, the gas spring 530 may rotate the tiller head 130 to the position P. The homing module 300 and more particularly the disks 310, 320 and coil spring 330 or another mechanism (e.g., disk spring or other resilient member with the disks 310, 320 or two complementary springs) may rotate the tiller 120 around the axis A1 to align the tiller 120 with the axis A1. The gas spring 610 may rotate the tiller 120 around the axis A2 to align the tiller 120 with axis A2. The operations of the gas spring 530, homing module 300, and gas spring 610 may be simultaneous, in series, or a combination.

According to an aspect of the present technology, a high payload autonomous mobile robot is provided, comprising: a body; a tiller having a first end coupled to the body and a second end having a handle, the first end being opposite the second end; a rotatable coupler coupling the tiller to the body; and means for restoring the tiller to a default rotational orientation relative to the body. In some embodiments, the high payload autonomous mobile robot has an autonomous operating mode, and the means for restoring the tiller to the default orientation restores the tiller to the default orientation in the autonomous operating mode. In some embodiments, the means is positioned between the body and the rotatable coupler. In some embodiments, the means is a passive means.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be object of this disclosure. Accordingly, the foregoing description and drawings are by way of example only.

What is claimed is:

1. A high payload autonomous mobile robot, comprising:
a body;
a rotatable coupler coupled to the body;
a tiller configured to rotate relative to the body around a first axis and a second axis, wherein the tiller is coupled to the body by the rotatable coupler and configured to rotate around the first axis through action of the rotatable coupler;
a tiller head coupled to the tiller and having a wider footprint than the tiller; and
a homing module coupled between the body and the rotatable coupler and configured to return the tiller to a default orientation about the second axis.

2. The high payload autonomous mobile robot of claim 1, wherein the homing module comprises complementary sliding disks having a keyed orientation relative to each other.

3. The high payload autonomous mobile robot of claim 2, wherein the complementary sliding disks have respective ramped surfaces facing each other and which in combination define the keyed orientation.

4. The high payload autonomous mobile robot of claim 2, wherein the complementary sliding disks comprise a first disk of a first material and a second disk of a second material softer than the first material.

5. The high payload autonomous mobile robot of claim 2, wherein the homing module comprises a resilient member configured to supply a restoring force against a first sliding disk of the complementary sliding disks.

6. The high payload autonomous mobile robot of claim 5, wherein the resilient member is a coil spring.

7. The high payload autonomous mobile robot of claim 5, further comprising a spring configured to control motion of the tiller about the first axis.

8. The high payload autonomous mobile robot of claim 1, wherein the homing module is a passive module.

9. A high payload autonomous mobile robot, comprising:
a body;
a controller configured to operate the high payload autonomous mobile robot in an autonomous mode;
a tiller configured for use in a manual mode of the high payload autonomous mobile robot; and
a homing module coupled to the body and configured to return the tiller to a default rotational orientation relative to the body in the autonomous mode.

10. The high payload autonomous mobile robot of claim 9, wherein the homing module comprises complementary sliding disks having a keyed orientation relative to each other.

11. The high payload autonomous mobile robot of claim 10, wherein the complementary sliding disks have respective ramped surfaces facing each other and which in combination define the keyed orientation.

12. The high payload autonomous mobile robot of claim 10, wherein the complementary sliding disks comprise a first disk of a first material and a second disk of a second material softer than the first material.

13. The high payload autonomous mobile robot of claim 12, wherein the first material is nylon.

14. The high payload autonomous mobile robot of claim 10, wherein the homing module comprises a resilient member configured to supply a restoring force against a first sliding disk of the complementary sliding disks.

15. The high payload autonomous mobile robot of claim 14, wherein the resilient member is a coil spring.

16. The high payload autonomous mobile robot of claim 15, further comprising a spring configured to control an angle of the tiller relative to vertical.

17. A high payload autonomous mobile robot, comprising:
a body;
a tiller having a first end coupled to the body and a second end having a handle, the first end being opposite the second end;
a rotatable coupler coupling the tiller to the body; and
means for restoring the tiller to a default rotational orientation relative to the body.

18. The high payload autonomous mobile robot of claim 17, wherein the high payload autonomous mobile robot has an autonomous operating mode, and wherein the means for restoring the tiller to the default orientation restores the tiller to the default orientation in the autonomous operating mode.

19. The high payload autonomous mobile robot of claim 17, wherein the means is positioned between the body and the rotatable coupler.

20. The high payload autonomous mobile robot of claim 17, wherein the means is a passive means.
